(19) United States
(12) Patent Application Publication
(10) Pub. No.: US 2026/0189020 A1
(43) Pub. Date: Jul. 2, 2026

(54) POWER SUPPLY RECEIVING MULTIPLE ALTERNATING CURRENT POWER SOURCES

(71) Applicant: HANWHA SOLUTIONS CORPORATION, Seoul (KR)

(72) Inventors: Seok Yong Hong, Seoul (KR); Sang Yong Park, Seoul (KR); Se Jin Kim, Seoul (KR); Ji Cheol Lee, Seoul (KR)

(21) Appl. No.: 19/336,574

(22) Filed: Sep. 23, 2025

(30) Foreign Application Priority Data
Dec. 26, 2024 (KR) 10-2024-0196544

(51) Int. Cl. H02J 3/46; H02J 3/32; H02M 7/08

(52) U.S. Cl. CPC H02J 3/46; H02J 3/32; H02M 7/08; H02J 2101/24

(57) ABSTRACT

A power supply receiving multiple alternating current (AC) power sources is provided. The power supply includes an AC/direct current (DC) converter including a diode circuit connected to multiple AC power sources and a DC/DC converter configured to convert DC power output from the AC/DC converter into DC power for driving at least one DC load and output the DC power, wherein the AC/DC converter is further configured to form a power flow from one AC power source having a highest voltage among the multiple AC power sources.

### CROSS-REFERENCE TO RELATED APPLICATION

This application is based on and claims priority under 35 USC § 119 to Korean Patent Application No. 10-2024-0196544, filed on Dec. 26, 2024, in the Korean Intellectual Property Office, the disclosure of which is incorporated by reference herein in its entirety.

### BACKGROUND

### 1. Field

The embodiments below relate to a power supply receiving multiple alternating current (AC) power sources.

### 2. Description of the Related Art

In general, a switching mode power supply (SMPS) is designed to convert a single commercial AC power source into a stable direct current (DC) voltage. The SMPS disclosed in U.S. Patent Publication No. 2010/0122096 supports two power sources (AC and DC) as inputs, but even in this case, separate monitoring of the power sources is required when switching a power source supplied as power, and there is a limitation in that it is difficult to guarantee seamless operation during the switching.

In particular, there is no automatic switching function according to voltage fluctuations of a power source, and when power supply of one of the two power sources is interrupted, it is difficult to immediately switch to the other power source. These limitations prevent the SMPS from effectively utilizing multiple power sources, which may result in reduced efficiency and stability of a power supply system.

This description of the related art is technical information which was known by the inventors for deduction of the present invention or acquired during the deduction, and should not be considered as having necessarily been published before the pertinent application.

### SUMMARY

An object of the present invention is to provide an alternating current (AC)/direct current (DC) conversion switching power supply capable of efficiently managing multiple AC power sources and providing stable DC output.

The problems to be solved by the present invention are not limited to the problems mentioned above, and other problems and advantages of the present invention that are not mentioned above may be understood by the following descriptions and will be more clearly understood by embodiments of the present invention. In addition, it will be appreciated that the matters and advantages to be addressed by the present invention may be realized by the means and combinations thereof defined by the appended claims.

According to an aspect of the present disclosure, there is provided a power supply including an AC/DC converter including a diode circuit connected to multiple AC power sources; and a DC/DC converter configured to convert DC power output from the AC/DC converter into DC power for driving at least one DC load and output the DC power, wherein the AC/DC converter is further configured to form a power flow from one AC power source having a highest voltage among the multiple AC power sources.

According to a second aspect of the present disclosure, there is provided a power supply system including multiple AC power sources; at least one DC load consuming power generated from the multiple AC power sources; and a power supply configured to connect the multiple AC power sources and supply power from one AC power source among the multiple AC power sources to the at least one DC load, wherein the power supply includes an AC/DC converter including a diode circuit connected to the multiple AC power sources; and a DC/DC converter configured to convert high-voltage first DC power output from the AC/DC converter into low-voltage second DC power for driving the at least one DC load and output the low-voltage second DC power, wherein the AC/DC converter is further configured to form a power flow from one AC power source having a highest voltage among the multiple AC power sources.

### BRIEF DESCRIPTION OF THE DRAWINGS

The above and other aspects, features, and advantages of certain embodiments of the disclosure will be more apparent from the following description taken in conjunction with the accompanying drawings in which:

FIG. 1 is a diagram schematically illustrating a power supply system;

FIG. 2 illustrates a power supply system according to an embodiment;

FIG. 3 illustrates a power supply system according to another embodiment;

FIG. 4 is a schematic diagram illustrating a power supply according to an embodiment;

FIG. 5 is a diagram illustrating an example, in which a power supply forms a power flow from an alternating current (AC) power source having the highest voltage among multiple AC power sources, according to an embodiment;

FIG. 6 is a diagram illustrating another example, in which a power supply forms a power flow from an AC power source having the highest voltage among multiple AC power sources, according to an embodiment; and

FIG. 7 is a diagram illustrating another example, in which a power supply forms a power flow from an AC power source having the highest voltage among multiple AC power sources, according to an embodiment.

### DETAILED DESCRIPTION

The advantages and features of the present invention and the method for achieving them will become clear with reference to the embodiments described in detail below together with the drawings. However, the present invention is not limited to the embodiments presented below but may be implemented in various modes, and it is to be appreciated that all changes, equivalents, and substitutes that do not depart from the spirit and technical scope of the present invention are encompassed in the embodiments.

The terms used herein are merely used to describe particular embodiments and are not intended to limit the present invention. An expression used in the singular encompasses the expression of the plural unless it has a clearly different meaning in the context. In this application, it is to be understood that terms, such as “including,” “comprising,” and “having” are intended to indicate the existence of features, numbers, steps, actions, components, parts, or combinations thereof disclosed in the specification and are not intended to preclude the possibility that one or more other features, numbers, steps, actions, components, parts, or combinations thereof may exist or may be added.

Furthermore, the connecting lines or connecting members between components in the drawings are intended to represent exemplary functional relationships and/or physical or logical connections between the components. It should be noted that many alternative or additional functional relationships, physical connections, or logical connections may be present in a practical device.

The present disclosure will be described in detail with reference to the accompanying drawings below.

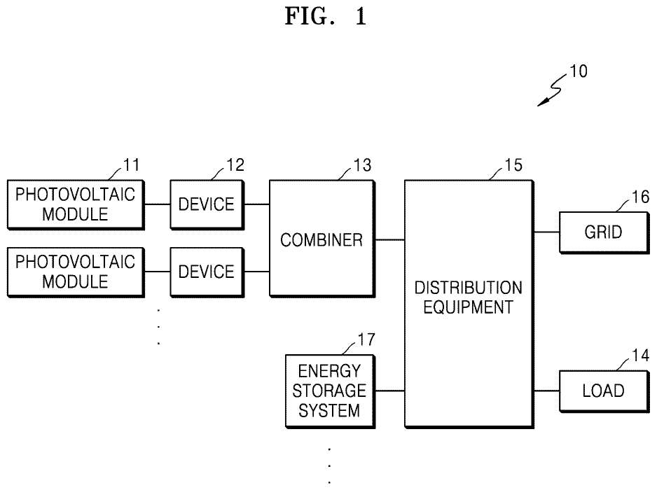

FIG. 1 is a diagram schematically illustrating a power supply system.

Referring to FIG. 1, a power supply system 10 may include a photovoltaic module 11, a device 12, a load 14, and/or distribution equipment 15. The power supply system 10 may be connected to an external grid 16.

At least one photovoltaic module 11 may be installed on the roof or exterior wall of a building and may generate electricity. A plurality of photovoltaic modules 11 may be connected to form a photovoltaic module array.

The photovoltaic module 11 may be connected to the device 12. For example, at least one device 12 may be connected to each photovoltaic module 11. For example, when one device 12 is connected to each photovoltaic module 11, the number of devices 12 constituting the power supply system 10 may be the same as the number of photovoltaic modules 11.

A device 12 may correspond to a power conditioning system or power conversion system (PCS) that performs power conversion with respect to power generated from a photovoltaic module 11. For example, the device 12 may perform certain conversion on power generated from the photovoltaic module 11 and supply converted power to other components (e.g., the grid 16 and/or the load 14) of the power supply system 10.

The device 12 may correspond to module level power electronics (MLPE). For example, the device 12 may be an optimizer or a microinverter (MI).

For example, when the device 12 is an optimizer, the device 12 may regulate power produced from the photovoltaic module 11 and output the power to an inverter (e.g., a string inverter). Current resulting from conversion (e.g., from direct current (DC) into alternating current (AC)) by the inverter may be output to the grid 16 or the load 14.

For example, when the device 12 is an MI, the device 12 may convert power generated from the photovoltaic module 11 (e.g., from DC to AC). The current converted by the device 12 may be output to the grid 16 or the load 14.

When necessary, the power supply system 10 may further include a combiner 13. At least some of the devices 12 may be connected to the distribution equipment 15 via the combiner 13. For example, power output from a plurality of devices 12 may be combined into one output by the combiner 13 and supplied to the distribution equipment 15.

The device 12 and the distribution equipment 15 may be connected to a power path that does not include the combiner 13. At least one device 12 may be connected to the distribution equipment 15 through a power path that does not include the combiner 13, and at least one other device 12 may be connected to the distribution equipment 15 via the combiner 13.

The combiner 13 may control voltage, current, and/or power output from the device 12 according to the power supply state of the photovoltaic module 11, the device 12, and/or the grid 16 and may set the operating mode thereof to a diagnosis mode, an operation mode, or the like.

The combiner 13 may include an energy management system (EMS) that controls the operation of the combiner 13. The EMS may control voltage, current, and/or power, which is supplied to or output from the combiner 13, according to the power supply state of the photovoltaic module 11, the device 12, and/or the grid 16 and may set the operating mode of the combiner 13 to the diagnosis mode, the operation mode, or the like.

The load 14 may refer to an object that is installed in an electricity consumer, such as a house, a commercial facility, or a factory, and operates by receiving at least one of energy generated by the photovoltaic module 11, energy stored in an energy storage system 17, and energy supplied from the grid 16. For example, when an electricity consumer supplied with power is a house, the load 14 may include a home appliance, such as a washing machine, a refrigerator, or a television (TV).

The grid 16 may include an infrastructure system for power generation, transmission, and distribution. For example, the grid 16 may include infrastructure systems, such as a power plant, a substation, and a power line. The grid 16 may transmit electric energy generated from a power plant to the power supply system 10 or transmit surplus power generated in the power supply system 10 to the outside of the power supply system 10.

For example, commercial power transmitted from the grid 16 through a power pole may be supplied to a power consumer through a transformer. The power supply system 10 may be implemented as an off-grid system that is not connected to the grid 16.

The power supply system 10 may further include at least one energy storage system 17. When necessary, the power supply system 10 may include a plurality of energy storage systems 17. The energy storage system 17 may receive and store power generated by the photovoltaic module 11 and/or power transmitted from the grid 16. The energy storage system 17 may efficiently supply power by storing power and supplying power to the load 14 when the load 14 needs the power.

The energy storage system 17 may include a battery that stores power and a power conversion module. The battery may be equipped with a battery management system (BMS), which monitors the state of charge (SOC), the state of health (SOH), the voltage, and/or the current of the battery, diagnoses the battery, and performs a safety function, such as current blocking.

The power conversion module may correspond to a PCS that performs conversion between power of a battery and power of a part opposite the battery. For example, the PCS may perform conversion between DC of a battery and AC of an opposite part. For example, the PCS may include a bidirectional DC/DC converter, which is connected to a battery and converts voltage, and a bidirectional inverter, which connects the DC/DC converter to the outside of the energy storage system 17.

The energy storage system 17 may further include an EMS that controls the operation of the energy storage system 17. The EMS may control voltage, current, and/or power, which is supplied to or output from the energy storage system 17, according to the power supply state of a battery and/or the grid 16 and may set the operating mode of the energy storage system 17 to the diagnosis mode, the operation mode, or the like.

When necessary, an EMS coupled to a certain component of the power supply system 10 may control not only the operation of the certain component but also the operation of another component of the power supply system 10. For example, an EMS coupled to the combiner 13 or an EMS coupled to the energy storage system 17 may control the operations of both the combiner 13 and the energy storage system 17.

The distribution equipment 15 may provide electrical connection between components of the power supply system 10 and may control the power flow of the power supply system 10. For example, the distribution equipment 15 may electrically connect the photovoltaic module 11 to the load 14. For example, the distribution equipment 15 may be connected to the device 12 connected to the photovoltaic module 11 and may thus electrically connect the photovoltaic module 11 to the load 14. When necessary, the distribution equipment 15 may be further connected to at least one of the energy storage system 17 and the grid 16.

For example, the distribution equipment 15 may correspond to a distribution panel that distributes power in the power supply system 10. For example, the distribution equipment 15 may correspond to a master service panel (MSP) that distributes power generated from the photovoltaic module 11 to the load 14 or the like.

For example, the distribution equipment 15 may correspond to a main controller, which performs power distribution in the power supply system 10 and controls each device 12. For example, the main controller may include a switch, a circuit breaker, and a control unit. The switch, the circuit breaker, and the control unit may each be implemented as an independent device, or at least some of the switch, the circuit breaker, and the control unit may be included in a single device.

The main controller may include a switch that controls electrical connections between components, such as the device 12 and the load 14, which are connected to the main controller. For example, the main controller may include a relay or a power semiconductor that provides or blocks electrical connection to the device 12 and/or the energy storage system 17 according to the driving state of each component of the power supply system 10.

The main controller may perform rapid shutdown to stop the power generation of the photovoltaic module 11 in an emergency situation, such as occurrence of overcurrent in the power supply system 10. For this operation, the main controller may include a circuit breaker that blocks the connection between the device 12 and the load 14.

The main controller may include a control unit that generally controls operations of the main controller. The control unit may also control operations of a component (e.g., the device 12 or the energy storage system 17) of the power supply system 10 other than the main controller.

The control unit may control voltage, current, and/or power, which is output from or supplied to each component, according to a power supply state of the photovoltaic module 11, the device 12, the combiner 13, the load 14, the grid 16, and/or the energy storage system 17. The control unit may also set the operating mode of the main controller, the device 12, and/or the energy storage system 17 to the diagnosis mode, the operation mode, or the like.

For example, the control unit may control the photovoltaic module 11, the device 12, the combiner 13, and/or the energy storage system 17, based on a state of the power supply system 10. For example, the control unit may enable the main controller to communicate with another component (e.g., the device 12) of the power supply system 10, thereby controlling another component of the power supply system 10. Communication between the main controller and another component of the power supply system 10 may be performed using power line communication (PLC) but is not limited thereto.

For example, the control unit may control the device 12 according to the power generation state of the photovoltaic module 11. For example, the main controller may receive a control command from a server that monitors the power generation state of the photovoltaic module 11, and the control unit may control the device 12 according to the control command.

The main controller may supply power to at least some of loads 14 when power supply from the grid 16 is not smooth (e.g., in an off-grid situation). For example, when the power supply from the grid 16 is not smooth, the main controller may preferentially supply power, which is generated from the photovoltaic module 11, and/or power, which is stored in the energy storage system 17, to a backup load that has a relatively high need for a stable power supply.

The power supply system 10 may further include an auxiliary power generation device (e.g., a diesel generator), which generates power in a separate manner other than solar power generation. For example, the auxiliary power generation device may be connected to the distribution equipment 15. When a backup load may not be handled by only the photovoltaic module 11 and the energy storage system 17 due to an environmental factor, such as a time zone or weather, the main controller may supply power generated by the auxiliary power generation device to the backup load.

The control unit may be implemented by at least one processor. A processor may process a command of a computer program by performing basic arithmetic, logic, and input/output operations. Here, the command may be provided from an internal memory of the main controller or from an external device. The processor may also generally control operations of other components included in the main controller.

The processor may perform at least some of data analysis, processing, and result information generation for performing the above-described operations by using at least one of machine learning, a neural network, or a deep learning algorithm, as a rule-based or artificial intelligence algorithm. Examples of neural networks may include architecture-based models, such as a convolutional neural network (CNN), a deep neural network (DNN), and a recurrent neural network (RNN).

For example, the processor may be implemented as an array of a number of logic gates or may be implemented as a combination of a general-purpose microprocessor and a memory storing a program that may be executed on the microprocessor. For example, the processor may include a general-purpose processor, a central processing unit (CPU), a microprocessor, a digital signal processor (DSP), a controller, a microcontroller, a state machine, or the like.

In some environments, the processor may include an application-specific integrated circuit (ASIC), a programmable logic device (PLD), a field programmable gate array (FPGA), or the like. For example, the processor may refer to a combination of processing devices, such as a combination of a DSP and a microprocessor, a combination of a plurality of microprocessors, a combination of one or more microprocessors in combination with a DSP core, or a combination of any other such components.

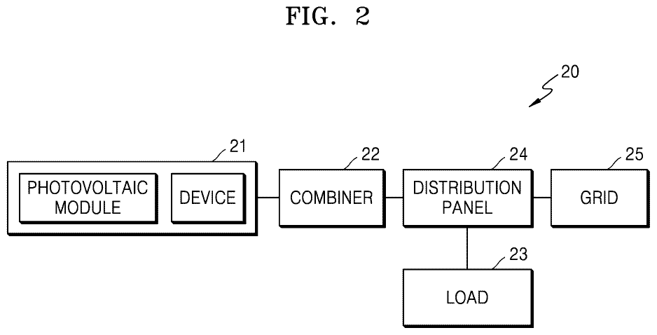

By combining at least some of the components described above, the power supply system 10 may be implemented in various forms. Hereinafter, various embodiments of the power supply system 10 will be described with reference to FIGS. 2 to 4. However, the implementation method of the power supply system 10 is not limited to the embodiment described below.

FIG. 2 illustrates a power supply system according to an embodiment.

Referring to FIG. 2, according to an embodiment, a power supply system 30 may include a photovoltaic system 31, a combiner 32, a load 33, a distribution panel 34, and an energy storage system 35. The power supply system 30 may be connected to an external grid 36.

The power supply system 30 illustrated in FIG. 2 may further include at least one energy storage system 35 compared to the power supply system 10 illustrated in FIG. 1. In an embodiment, the energy storage system 35 may be connected to the distribution panel 34 and may be charged or discharged. In another embodiment, the energy storage system 35 may be connected to the combiner 32 and may be charged or discharged.

When the power supply system 30 further includes the energy storage system 35, power stored in the energy storage system 35 may be used to respond to the load 33 in a case where the load 33 may not be handled by the photovoltaic system 31 alone. When power generated by the photovoltaic system 31 exceeds the amount of power required to respond to the load 33, the excess may be stored in the energy storage system 35. When the charge amount of the energy storage system 35 is below a threshold and power generated by the photovoltaic system 31 does not exceed the amount of power required to respond to the load 33, the energy storage system 35 may be charged with power supplied from the grid 36.

Accordingly, the power supply system 30 may efficiently supply power to the load 33 by using the energy storage system 35.

The combiner 32 may perform control voltage, current, and/or power, which is output from the photovoltaic system 31, according to the power supply state of the photovoltaic system 31, the power supply state of the load 33, and/or the power supply state of the grid 36, and the operating mode of the combiner 32 may be set to the diagnosis mode, the operation mode, or the like.

The energy storage system 35 may control voltage, current, and/or power, which is supplied to or output from the energy storage system 35, according to the power supply state of the photovoltaic system 31, the power supply state of the load 33, and/or the power supply state of the grid 36, and the operating mode of the energy storage system 35 may be set to the diagnosis mode, the operation mode, or the like.

In an embodiment, the power supply system 30 may further include a sub panel (not shown) connected to the distribution panel 34. In this case, at least one photovoltaic system 31 may be connected to the sub panel through the combiner 32, and at least one other photovoltaic system 31 may be directly connected to the sub panel.

At least one energy storage system 35 may be connected to the combiner 32, the distribution panel 34, or the sub panel and thus be integrated into the power supply system 30.

At least one photovoltaic system 31 may be connected to the distribution panel 34 through a power path that does not include the combiner 32. For example, at least one photovoltaic system 31 may be connected to the distribution panel 34 through a power path that does not include the combiner 32, and at least one other photovoltaic system 31 may be connected to the distribution panel 34 via the combiner 32.

In an embodiment, at least one photovoltaic system 31 may be connected to the sub panel via the combiner 32, and at least one other photovoltaic system 31 may be directly connected to the sub panel.

The power supply system 30 may increase the total amount of power generated by the photovoltaic system 31, which may be integrated into the power supply system 30, by including a sub panel that provides additional power capacity.

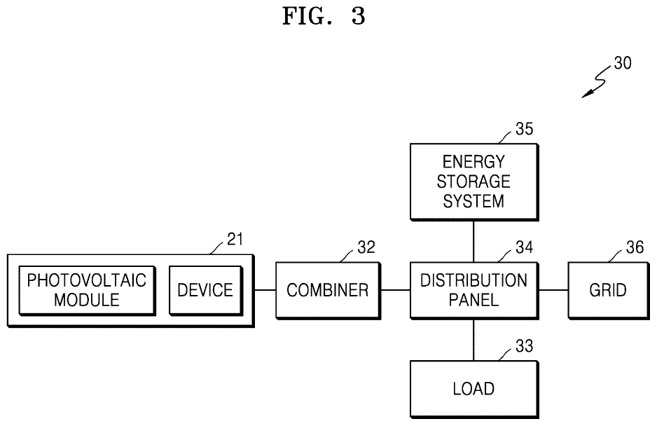

FIG. 3 illustrates a power supply system according to another embodiment.

Referring to FIG. 3, according to an embodiment, a power supply system 40 may include a photovoltaic system 41, a combiner 42, a load 43, a main controller 44, a distribution panel 45, and an energy storage system 46. The power supply system 40 may be connected to an external grid 47.

The photovoltaic system 41, the combiner 42, the load 43, and the energy storage system 46 in FIG. 3 may respectively correspond to the photovoltaic system 31, the combiner 32, the load 33, and the energy storage system 35 in FIG. 2. The main controller 44 in FIG. 3 may correspond to the main controller described above with reference to FIG. 1.

The combiner 42 may electrically connect at least one photovoltaic system 41 to the main controller 44. For example, the combiner 42 may combine power output from at least one photovoltaic system 41 into one output and may supply the output to the main controller 44.

The main controller 44 may electrically connect the combiner 42, the distribution panel 45, and the grid 47 to one another. The main controller 44 may connect the components described above to auxiliary power sources, such as the energy storage system 46 and/or an auxiliary power generator (e.g., a diesel generator, etc.). For example, the main controller 44 may output power supplied from the combiner 42 to the distribution panel 45, the energy storage system 46, and/or the grid 47. The main controller 44 may also output power supplied from the grid 47 to the distribution panel 45 or the energy storage system 46. The main controller 44 may also output power supplied from the energy storage system 46 to the distribution panel 45.

The distribution panel 45 may electrically connect the main controller 44 to at least one load 43. Accordingly, the power supply system 40 may supply power generated from the photovoltaic system 41 to the load 43 through the distribution panel 45.

The power supply system 40 may integrate a plurality of energy storage systems 46 and/or an auxiliary power generator into the power supply system 40 by including the main controller 44, thereby stably supplying power. In addition, the power supply system 40 may stably supply power to the load 43, such as a backup load, even in an off-grid environment where power may not be stably supplied from the grid 47.

The main controller 44 may control voltage, current, and/or power, which is output from or supplied to each component, according to the state of the photovoltaic system 41, the state of the load 43, the state of the energy storage system 46, and/or the state of the grid 47, and may set the operating mode of the main controller 44, the operating mode of the photovoltaic system 41, and/or the operating mode of the energy storage system 46 to the diagnosis mode, the operation mode, or the like.

In an embodiment, the power supply system 40 may further include a sub panel (not shown), which is connected to the main controller 44 and distinct from the distribution panel 45. In this case, at least one backup load having a relatively high need for stable power supply among a plurality of loads 43 may be connected to the sub panel, and at least one non-backup load having a relatively low need for stable power supply among the loads 43 may be connected to the distribution panel 45.

The main controller 44 may electrically connect the combiner 42, the distribution panel 45, the energy storage system 46, the grid 47, and the sub panel to one another. The main controller 44 may supply power, which is supplied from the combiner 42, the energy storage system 46, and/or the grid 47, to at least one non-backup load through the distribution panel 45 and to a backup load through a sub panel.

In an embodiment, the power supply system 40 may further include a sub panel, which is connected to the main controller 44 and distinct from the distribution panel 45, and the grid 47 may be connected to the distribution panel 45 instead of being connected to the main controller 44. That is, the main controller 44 may electrically connect the combiner 42, the distribution panel 45, the energy storage system 46, and the sub panel to one another, and the distribution panel 45 may electrically connect the main controller 44, the non-backup load, and the grid 47 to one another.

For example, the power supply system 40 may be implemented by connecting the main controller 44, which connects the combiner 42 to the energy storage system 46, to the distribution panel 45, which is pre-installed to connect at least one load 43 to the grid 47.

Accordingly, the power supply system 40 may stably supply power to the load 43, such as a backup load, even in an off-grid environment where power may not be stably supplied from the grid 47.

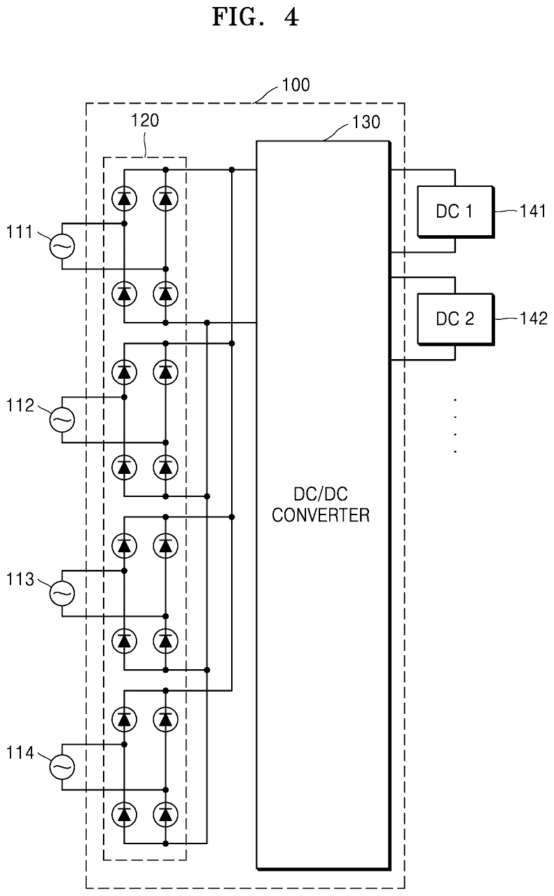

FIG. 4 is a schematic diagram illustrating a power supply according to an embodiment.

A power supply 100 in FIG. 4 may be included in the distribution equipment or the main controller, each described above with reference to FIGS. 1 to 3, but is not limited thereto.

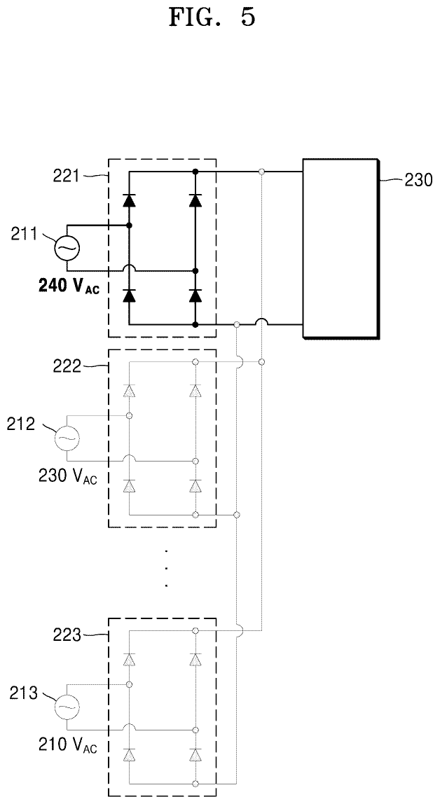

Referring to FIG. 4, according to an embodiment, the power supply 100 may include a diode circuit 120, which is connected to multiple AC power sources 111, 112, 113, and 114, and a DC/DC converter 130, which converts DC power output from an AC/DC converter into DC power for driving one or more DC loads 141 and 142 and outputs the converted DC power. Only components related to the embodiment are shown in the power supply 100 in FIG. 5. Accordingly, it will be understood by one of ordinary skill in the art that the power supply 100 may further include other general components in addition to the components illustrated in FIG. 4.

In an embodiment, the power supply 100 may be configured as a switching mode power supply (SMPS). An SMPS is a power supply that uses high-speed switching technology to efficiently convert power and performs the function of converting AC power into DC and then adjusting the DC to a required voltage level before outputting the DC.

In an embodiment, the AC power sources 111, 112, 113, and 114 may include at least one of a grid, a power generator, an energy storage system, and an inverter. An AC power source, such as an electric vehicle (EV) charger or a fuel cell, may also be included in the AC power sources 111, 112, 113, and 114.

In an embodiment, a grid may correspond to an AC power source of an external grid that is provided to a consumer via a power line and a transformer. A power generator may correspond to an auxiliary power generator that independently generates power regardless of an external grid. For example, the power generator may include a diesel generator that generates power in a separate manner other than a photovoltaic manner.

In an embodiment, an energy storage system (ESS) may refer to a system that store power generated from various power sources and stably supply the power when needed. The ESS may primarily play a role in compensating for the irregularities of power generated from renewable energy sources, such as sunlight and wind power, and stabilizing power supply and demand by supplying power in a peak load time zone.

In an embodiment, the ESS may store DC power generated from at least one solar panel and, when needed, may provide AC power by converting the DC power into AC. Accordingly, photovoltaic energy may be stored and utilized, and supply of power may be maintained even in an independent environment not connected to an external grid.

In an embodiment, an inverter may convert DC power generated by a solar panel into AC power and may output the AC power. A photovoltaic module may correspond to a device that directly converts solar energy into electrical energy and may include a plurality of photovoltaic cells. A photovoltaic cell may be manufactured using a semiconductor material. When sunlight reaches the photovoltaic cell and photons interact with electrons in a semiconductor, DC power may be generated through the movement of electrons. A photovoltaic module, in which a plurality of cells are connected to each other, may generate, collect, and output DC power.

The DC power may be converted into AC power by an inverter. The inverter may directly supply the AC power to a grid or various loads or may store the AC power in an ESS. The ESS may convert the AC power output from the inverter into DC and store the DC.

For example, the inverter may include an MI, which is attached to a photovoltaic module, or a string inverter, which is electrically connected to a photovoltaic module array constituted of a plurality of photovoltaic modules. The MI may refer to a small inverter that is attached to an individual photovoltaic module and converts DC power generated by the photovoltaic module into AC. The string inverter may be separated from a photovoltaic module array consisting of a plurality of photovoltaic modules by a certain distance and may be electrically connected to the photovoltaic module array through electrical wiring.

That is, in an embodiment of the present invention, the inverter may not be a configuration that directly generates voltage but may receive DC power, convert the DC power into AC power, and outputs the AC power. The magnitude of the output voltage may be determined by an input voltage provided by a photovoltaic module or an external power source.

According to an embodiment, the diode circuit 120 may include a plurality of individual diode circuits respectively connected to multiple AC power sources. An individual diode circuit may be configured to rectify and convert its corresponding AC power source into DC power. For example, the individual diode circuit may include four diodes arranged in a configuration of a diode bridge rectifier and may convert AC to DC.

Rectification may refer to a process of converting AC power into DC power. A diode bridge rectifier may convert both half-cycles of an AC voltage into DC.

According to some embodiments, the diode bridge rectifier may include more than four diodes and may be configured in various forms to meet power requirements by connecting a plurality of diodes in parallel or series to accommodate high voltage or high current conditions.

In an embodiment, a plurality of individual diode circuits may each include an input terminal, which receives its corresponding AC power source, and a DC output terminal. That is, the power supply 100 including the diode circuit 120 may include multiple input terminals that receive multiple power sources.

DC output terminals of a plurality of individual diode circuits may be connected to each other, thereby forming a DC common bus. That is, all DC output terminals may be collectively connected to form a DC common bus that commonly accepts and transmits DC power so that converted power may be managed and distributed in a centralized manner.

A diode bridge rectifier may have a structure that converts both half-cycles of an AC voltage into a DC voltage by using the unidirectional characteristic of a diode. Through this rectification process, power output from each AC power source may be converted into DC form, collected into a DC common bus, and transmitted to the DC/DC converter 130.

The diode circuit 120 composed of a passive element may operate such that a power flow is spontaneously formed only in a power source having a highest voltage without any specific control. Due to the nature of a diode, a power flow may not occur in a power source having a low voltage, and a power flow may be spontaneously formed only in a high-voltage power source.

When a voltage drop occurs in the power source having the highest voltage, the power flow may automatically shift to a new power source having a highest voltage so that a seamless power flow transition may occur. This is because the diode circuit 120 forms a power flow by giving priority to a power source having a highest voltage. No separate switch or control may be required for transition.

The DC/DC converter 130 may convert a DC voltage, which is supplied from a DC common bus, into DC power for driving one or more DC loads 141 and 142 and may output the DC power

In an embodiment, the DC/DC converter 130 may convert high-voltage first DC power, which is supplied from a DC common bus, into low-voltage second DC power. According to an embodiment of the present invention, in an environment including high-voltage multi-input power sources, such as a grid, a power generator, and an ESS, the power sources may be collected and gathered into a DC common bus, and a power flow may be formed from one power source having a highest voltage among the power sources. Most electronic devices, such as computers, communication equipment, and sensors, or small devices may reliably operate only at a low voltage, e.g., 3.3 V, 5 V, 12 V, or 24 V. Therefore, the DC/DC converter 130 may convert a high voltage of the DC common bus into a low voltage and may supply a voltage suitable for a final load.

For example, the DC/DC converter 130 may include a switching regulator that converts an input voltage into a desired output voltage by using a high-speed switching element, an inductor, a capacitor, etc.

The DC/DC converter 130 may have a multi-output switching regulator structure capable of distributing a single-input voltage to multiple output ports, and each output port may be adjusted to provide an output voltage and current that meets a condition needed by a connected DC load.

That is, the DC/DC converter 130 may include a plurality of output terminals, and each output terminal may maintain an individual output voltage through a separate feedback circuit and a separate control logic. For example, a first output may be set to 5 V, a second output to 12 V, a third output to 24 V, etc. so as to meet the needs of various loads.

According to an embodiment, the power supply 100 of the present invention may be provided to implement a smart distribution panel and may be included in or may correspond to the distribution device or the main controller, which has been described above with reference to FIGS. 1 to 3. A smart distribution panel may be a hub, which is connected to various power resources (e.g., an ESS, a grid, a power generator, etc.) and may automatically select a power source and optimize distribution. While a typical distribution panel simply supplies power or blocks power supply, a smart distribution panel may comprehensively manage multiple power resources so as to enable efficient and stable power supply according to power demand. Accordingly, there may be provided a system that maximizes power efficiency and distributes or switches power according to the state and priority of each power source when necessary.

FIGS. 5 to 7 are diagrams illustrating examples of power flows formed when multiple AC power sources including a grid, a power generator, and an inverter (e.g., an MI or a string inverter) are connected a power supply, according to an embodiment.

FIG. 5 is a diagram illustrating an example, in which a power supply forms a power flow from an AC power source having the highest voltage among multiple AC power sources, according to an embodiment.

Referring to FIG. 5, the power supply may include a plurality of individual diode circuits 221, 222, and 223 and a DC/DC converter 230. The individual diode circuits 221, 222, and 223 may be respectively connected to respective AC power sources, e.g., a grid 211, a power generator 212, and an MI 213. Each diode circuit may rectify and convert a connected AC power source into DC.

For example, when the voltages of the grid 211, the power generator 212, and the MI 213 are 240 V, 230 V, and 210 V, respectively, a power flow may be formed from the grid 211 having the highest voltage. At this time, due to the characteristics of a diode circuit, current may not flow from the power generator 212 and the MI 213, each having a low voltage, and may be blocked. This may be possible because a diode blocks reverse current in a low-voltage path.

Accordingly, only the grid 211 that is a power source having a highest voltage, may supply power to the DC/DC converter 230, and the DC/DC converter 230 may stabilize and convert the supplied DC voltage into DC power required by at least one DC load and may output the DC power.

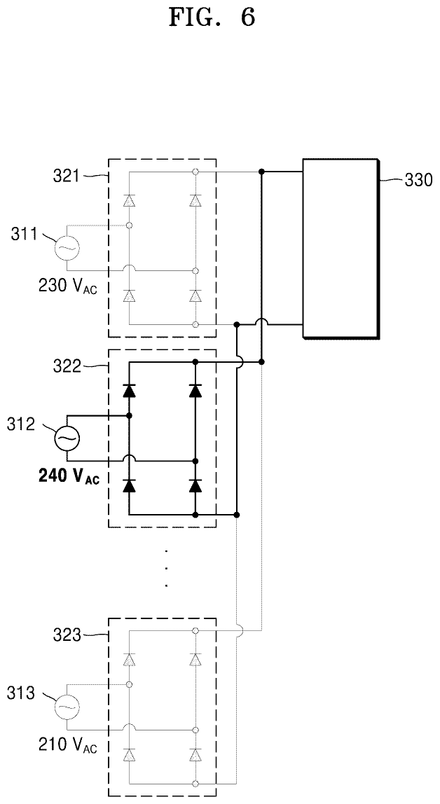

FIG. 6 is a diagram illustrating another example, in which a power supply forms a power flow from an AC power source having the highest voltage among multiple AC power sources, according to an embodiment.

Referring to FIG. 6, the power supply may include a plurality of individual diode circuits 321, 322, and 323 and a DC/DC converter 330. The individual diode circuits 321, 322, and 323 may be respectively connected to AC power sources, e.g., a grid 311, a power generator 312, and an MI 313.

For example, when the voltages of the grid 311, the power generator 312, and the MI 313 are 230 V, 240 V, and 210 V, respectively, a power flow may be formed from the power generator 312 having the highest voltage, and no power flows from the other power sources.

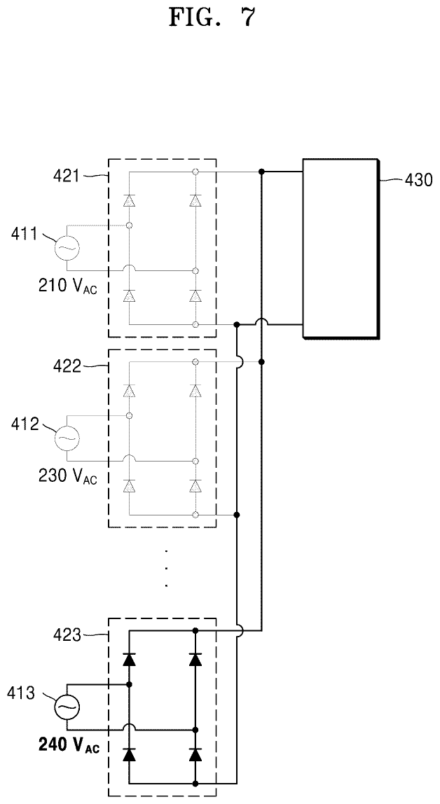

FIG. 7 is a diagram illustrating still another example, in which a power supply forms a power flow from an AC power source having the highest voltage among multiple AC power sources, according to an embodiment.

Referring to FIG. 7, the power supply may include a plurality of individual diode circuits 421, 422, and 423 and a DC/DC converter 430. The individual diode circuits 421, 422, and 423 may be respectively connected to AC power sources, e.g., a grid 411, a power generator 412, and an MI 413.

For example, when the voltages of the grid 411, the power generator 412, and the MI 413 are 210 V, 230 V, and 240 V, respectively, a power flow may be formed from the MI 413 having the highest voltage, and power flows from the other power sources may be blocked.

When power from a grid is supplied, as a power source, to a power supply according to an embodiment, the voltage level of the grid may usually be maintained higher than that of other power sources. However, even while the power from the grid is being supplied, in a certain situation due to temporary instability in the grid or the like, there may be a power source having a higher voltage than the grid. In this case, because the power supply according to an embodiment of the present invention is configured such that a power flow is formed from a power source having a highest voltage, power may be supplied preferentially from another power source having a higher voltage than the grid.

Therefore, according to an embodiment of the present invention, a process of setting priorities according to the types of power sources may not be necessary, and an optimal power flow may be automatically determined according to the magnitude of the voltage of each power source regardless of whether specific type of power source is supplied, thereby enabling stable power supply.

Although FIGS. 5 to 7 illustrate examples in which power sources of a grid, a power generator, and an inverter are supplied as multiple AC power sources, the power supply of the present invention may be more useful in cases where power from a grid is not supplied.

For example, when a power generator, an ESS, an MI, and a string inverter are used as multiple power sources, the voltage of the power generator usually remains highest in a situation where power from a grid is not supplied. As a power source that may provide a high output voltage on its own, a power generator may be likely to be a main power source in the absence of a grid. The voltage of an ESS may be likely to remain relatively high after the power generator. Because an MI or a string inverter is generally responsible for small-scale power conversion at a module level, the MI or the string inverter may rarely have the highest voltage and thus unlikely to be used as a main power source for power supply.

However, in a certain situation, the order of voltage magnitude between a power generator and an ESS may change. For example, when the power generator operates for a long period of time, a voltage drop may occur, causing an output voltage to temporarily decrease. At this time, the ESS may maintain a higher voltage than the power generator according to the charge state of a battery. Under such conditions, the power supply device of the present invention may be configured to automatically form a power flow according to a voltage magnitude so that in a situation where the voltage of the power generator is temporarily lowered, the power supply may supply power using the power of the ESS as a power source having the highest voltage.

Therefore, according to the present invention, even in an off-grid environment without a grid, appropriate power supply may be provided according to the voltage state of each of the power generator and the ESS, and energy management may be flexibly performed through automatic response to the voltage change of a power source.

The technical idea of the present invention is not limited to the embodiments of FIGS. 5 to 7, and the power supply of the present invention may receive power from various AC power sources, such as an EV charger and a fuel cell, and automatic switching of a power source, which forms a power flow among multiple AC power sources, may be implemented via a diode circuit.

According to the problem solving means of the present disclosure described above, a power flow may be formed from an AC input power source having the highest voltage among a plurality of AC input power sources so that even when a voltage drop occurs in the AC input power source forming the power flow, the power flow may be smoothly switched to another AC input power source, enabling stable power supply without separate monitoring.

In addition, smooth switching may be possible even when an additional AC input source is connected besides an existing AC input source so that high expandability and flexible power management may be provided. The effects of the embodiments are not limited to the effects mentioned above, and other effects that have not be mentioned can be clearly understood by one of ordinary skill in the art from the description of the present invention.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A power supply comprising:
an alternating current (AC)/direct current (DC) converter including a diode circuit connected to multiple AC power sources; and
a DC/DC converter configured to convert high-voltage first DC power output from the AC/DC converter into low-voltage second DC power for driving at least one DC load and output the low-voltage second DC power,
wherein the AC/DC converter is configured to form a power flow from one AC power source having a highest voltage among the multiple AC power sources.

2. The power supply of claim 1, wherein
the diode circuit includes
a plurality of individual diode circuits respectively connected to the multiple AC power sources, and
each of the plurality of individual diode circuits is configured to rectify and convert a corresponding AC power source among the multiple AC power sources into DC power.

3. The power supply of claim 2, wherein
each of the plurality of individual diode circuits includes
four diodes arranged in a diode bridge configuration.

4. The power supply of claim 2, wherein
each of the plurality of individual diode circuits includes:
an input terminal connected to the corresponding AC power source; and
a DC output terminal, and
respective DC output terminals of the plurality of individual diode circuits are connected to each other and form a DC common bus.

5. The power supply of claim 4, wherein
the DC/DC converter is further configured to
convert the high-voltage first DC power supplied from the DC common bus into the low-voltage second DC power.

6. The power supply of claim 2, wherein
the plurality of individual diode circuits
are connected in parallel to each other in the diode circuit.

7. The power supply of claim 1, wherein
the multiple AC power sources include
at least one of a grid, a power generator, an energy storage system, and an inverter.

8. The power supply of claim 7, wherein
the energy storage system is configured to store DC power generated from at least one photovoltaic module, convert the DC power into AC power, and output the AC power.

9. The power supply of claim 7, wherein
the inverter is configured to
convert DC power generated from a photovoltaic module into AC power and output the AC power.

10. The power supply of claim 9, wherein
the inverter includes
a microinverter attached to each of at least one photovoltaic module or a string inverter electrically connected to a photovoltaic module array constituted of a plurality of photovoltaic modules.

11. The power supply of claim 1, wherein
the power supply is
included in a distribution panel of a power supply system including a photovoltaic system, a grid, and an energy storage system.

12. A power supply system comprising:
multiple alternating current (AC) power sources;
at least one direct current (DC) load consuming power generated from the multiple AC power sources; and
a power supply configured to connect the multiple AC power sources and supply power from one AC power source among the multiple AC power sources to the at least one DC load,
wherein the power supply includes
an AC/DC converter including a diode circuit connected to the multiple AC power sources; and
a DC/DC converter configured to convert high-voltage first DC power output from the AC/DC converter into low-voltage second DC power for driving the at least one DC load and output the low-voltage second DC power,
wherein the AC/DC converter is further configured to form a power flow from one AC power source having a highest voltage among the multiple AC power sources.

13. The power supply system of claim 12, wherein
the diode circuit includes
a plurality of individual diode circuits respectively connected to the multiple AC power sources, and
each of the plurality of individual diode circuits is configured to rectify and convert a corresponding AC power source among the multiple AC power sources into DC power.

14. The power supply system of claim 13, wherein
each of the plurality of individual diode circuits includes:
an input terminal connected to the corresponding AC power source; and
a DC output terminal, and
respective DC output terminals of the plurality of individual diode circuits are connected to each other and form a DC common bus.

15. The power supply system of claim 14, wherein
the DC/DC converter is further configured to
convert the high-voltage first DC power supplied from the DC common bus into the low-voltage second DC power.

16. The power supply system of claim 13, wherein
the plurality of individual diode circuits
are connected in parallel to each other in the diode circuit.

17. The power supply system of claim 12, wherein
the multiple AC power sources include
at least one of a grid, a power generator, and an energy storage system.

18. The power supply system of claim 17, wherein
the energy storage system is configured to
store DC power generated from at least one photovoltaic module, convert the DC power into AC power, and output the AC power.

19. The power supply system of claim 12, wherein
the inverter is configured to
convert DC power generated from the at least one photovoltaic module into AC power and output the AC power.

20. The power supply system of claim 19, wherein
the inverter includes
a microinverter attached to each of the at least one photovoltaic module or a string inverter electrically connected to a photovoltaic module array constituted of a plurality of photovoltaic modules.
